(19) United States
(12) Patent Application Publication
(10) Pub. No.: US 2022/0027836 A1
(43) Pub. Date: Jan. 27, 2022

(54) YARD CHECK SYSTEM WITH CUSTOMER FEEDBACK

(71) Applicant: Schneider Enterprise Resources, LLC, Green Bay, WI (US)

(72) Inventors: Christopher Mossberg, Appleton, WI (US); Justin Sachs, Green Bay, WI (US); Stefanie Abitz-Grun, Green Bay, WI (US)

(73) Assignee: Schneider Enterprise Resources, LLC, Green Bay, WI (US)

(21) Appl. No.: 17/382,671

(22) Filed: Jul. 22, 2021

Related U.S. Application Data
(60) Provisional application No. 63/055,641, filed on Jul. 23, 2020.

(51) Int. Cl. G06Q 10/06; G06Q 10/08

(52) U.S. Cl. CPC G06Q 10/063114; G06Q 10/087; G06Q 10/0833; G06Q 10/06315

(57) ABSTRACT

A system and method include determining, upon receiving an indication to assign a trailer to an order, an empty trailer from a plurality of trailers, wherein the empty trailer is identified based on customer feedback and assigning the empty trailer to the order.

### CROSS-REFERENCE TO RELATED APPLICATION

This application claims the benefit of and priority to U.S. Provisional Application No. 63/055,641, filed on Jul. 23, 2020, the entirety of which is incorporated by reference herein.

### BACKGROUND

Customers often use trailers to ship freight from one location to another. The trailers may be owned and/or operated by a carrier. Management of a customer's orders also entails management of the trailers allocated by the carrier to the customer. However, current mechanisms of integrating order management with trailer management are generally unknown, and to the extent that such mechanisms are known, such mechanisms are inadequate.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a method is disclosed. The method includes identifying, upon receiving an indication to assign a trailer to an order, an empty trailer from a plurality of trailers. The empty trailer is identified based on customer feedback. The method also includes assigning the empty trailer to the order.

In accordance with further embodiments of the present disclosure, one or more non-transitory computer-readable storage media having computer-readable instructions stored thereon are disclosed. The computer-readable instructions when executed by a processor of a yard check application cause the processor to identify, upon receiving an indication to assign a trailer to an order, an empty trailer from a plurality of trailers. The empty trailer is identified based on customer feedback. The computer-readable instructions when executed by the processor also cause the processor to assign the empty trailer to the order.

In accordance with further embodiments of the present disclosure, one or more non-transitory computer-readable storage media having computer-readable instructions stored thereon are disclosed. The computer-readable instructions when executed by a processor of a yard check application cause the processor to receive customer feedback indicating that a trailer has been loaded for transportation from a customer yard to a destination, determine a pick-up location of the customer yard, determine a pick-up date by which the trailer is to be picked up, and assign a transport vehicle to pick up the trailer from the pick-up location by the pick-up date for transporting the trailer to the destination.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a computing system implementing a yard check application, in accordance with some embodiments of the present disclosure.

FIG. 2 is an example block diagram showing additional details of the yard check application of FIG. 1, in accordance with some embodiments of the present disclosure.

FIG. 3 is an example flowchart outlining operations of a process for assigning an empty trailer to a current order, in accordance with some embodiments of the present disclosure.

FIG. 4 is an example flowchart outlining operations of a process for taking action based upon customer feedback, in accordance with some embodiments of the present disclosure.

FIG. 5 is another example flowchart outlining certain operations of FIG. 4 in greater detail, in accordance with some embodiments of the present disclosure.

FIG. 6 is yet another example flowchart outlining certain operations of FIG. 4 in greater detail, in accordance with some embodiments of the present disclosure.

FIG. 7 is an example flowchart outlining operations of a process for managing loaded trailers, in accordance with some embodiments of the present disclosure.

FIGS. 8A and 8B are example user interfaces of the yard check application of FIG. 1 showing an assignment of an empty trailer to a current order of FIG. 3, in accordance with some embodiments of the present disclosure.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

A shipping yard, which also may be referred to as a container yard, a yard, a container port, a shipping terminal, etc., is a location where a trailer used for transporting freight may be temporarily stored. A trailer may be any storage box, van, wagon, or the like that may be used to store and move freight from one location to another. The trailer may be configured to be moved by any suitable transportation medium including road, air, rail, and/or water using any type of suitable transportation vehicle such as truck, train, air (planes/helicopters), intermodal (combination of transportation modes, such as truck and train), etc. It is to be understood that the terms “load,” “freight,” “cargo,” and “shipment” are used synonymously/interchangeably to describe goods transported in the trailers.

In some embodiments, a trailer may be owned and/or operated by a carrier. The carrier may allocate one or more trailers to a customer for transporting the customer's freight from one location to another pursuant to one or more orders. In some embodiments, the trailers allocated to the customer may be temporarily parked at a customer's yard to unload and/or load cargo during a delivery route. In some embodiments, the delivery route may include one or more source locations from where the trailer picks up freight and one or more destination locations where the trailer delivers the freight. In some embodiments, the trailers may be temporarily parked at the yard when the trailer is not currently in use (e.g., for maintenance or awaiting assignment to an order). In other embodiments, a trailer may stop at the yard when scheduled delivery routes and estimated delivery times for shipments change due to inclement weather, heavy traffic, road accidents, etc. For example, due to dangerous road conditions from an unexpected snowstorm, a trailer may stop at a yard.

Further, the customer may use an order management system or customer portal to manage the customer's orders. The order management system may be used to create, update, or otherwise manage existing and new orders, manage inventory, sales, etc. The carrier may use a trailer management system to manage the trailers allocated to the customer and to other entities. For example, the trailer management system may be used to determine a current status of the trailers allocated to the customer. Such order management systems and trailer management systems are limited in their ability to manage orders and trailers, respectively. Specifically, technical problems exist due to the order management systems and trailer management systems operating independently as separate components. For example, order management systems do not have the ability to track the current status of trailers. Thus, assigning a trailer to an order requires a time consuming process by which the customer needs to first identify which trailers are available and empty on the yard to carry the cargo. Delays in determining this information may cause an increase in likelihood that orders and shipments are delayed. In some cases, all of the customer's trailers may already be assigned to other orders. Without having the ability to track the current status of the trailers, the customer may not know when a trailer is expected to become available, further delaying the shipment.

Similarly, technical problems exist in trailer management systems. For example, a trailer management system may determine the current status of a customer's trailers, but does not have the ability to use that status for order management. In some cases, the trailer management system may check for and update the status of trailers at predetermined intervals. If the status of a particular trailer changes (e.g., due to being assigned to an order) between two status check intervals of the trailer management system, the status of that trailer as determined by the trailer management system may not be updated until the trailer management system updates the status again. Thus, if the current statuses of the trailers are changing at a higher frequency than the frequency at which the trailer management system is updating the statuses, the trailers may have inaccurate statuses.

Thus, the operation of both, the order management system and the trailer management system, may suffer from independent and exclusive operation. The present disclosure, thus, provides technical solutions to integrate a customer's order management system with a carrier's trailer management system. The integrated order and trailer management system improves the operation and functioning of both the order management system and the trailer management system. For example, the trailer management system may consider customer feedback in updating or augmenting the current status of the trailers, thereby providing an accurate real-time or substantial real-time status of each trailer allocated to a customer. The trailer management system may also provide an accurate and up-to-date view to the customer of where the customer's trailers are at any given point. For example, the trailer management system may allow the customer to track the trailer location and/or status within shipping yards across several geographic locations (e.g., cities) and customer sites. In some embodiments, in a delivery route with various stops at shipping yards of customer sites, improving the accuracy of determining the current location of the trailer and a current status of the trailer within shipping yards, such as empty, outbound loaded, or inbound loaded, may be advantageous. Likewise, the order management system may rely on the accurate and up-to-date status information from the trailer management system to manage order assignments. Beneficially, customers may vastly improve efficiency with the ability to easily and quickly view trailer locations and the status of the trailers within shipping yards. In addition, the present disclosure presents mechanisms to track freight status, including information on each stop location (e.g., at a shipping yard) on a delivery route, a detailed, interactive map of the delivery route for the freight, and a capability to quickly export the data. The order management system may also assign trailers to orders quickly, send requests to the carrier to pick up a loaded trailer for transporting to a destination, and request other actions to be performed on the trailers.

Particularly, the present disclosure provides a yard check application including a yard check engine that integrates a trailer management system with a customer's order management system. In some embodiments, the yard check application may be integrated with an existing order management system of the customer, thereby avoiding the need to reconfigure or recreate the customer's order management system. The yard check application may be configured to determine trailer status information and track a current location of the trailers based upon sensor data, as well as order information retrieved from the order management system. Additionally, the yard check application makes the determined trailer status information available to the order management system to allow the order management system to quickly and easily assign trailers to orders. Based upon customer feedback, the yard check application may also manage the fleet of transport vehicles that move the trailers from one location to another.

Integrating trailer management with order management may greatly save customers time and other resources in planning shipments and trailer allocation, loading trailers with cargo, unloading trailers, and so on by having real-time monitoring of the trailer and cargo status and locations.

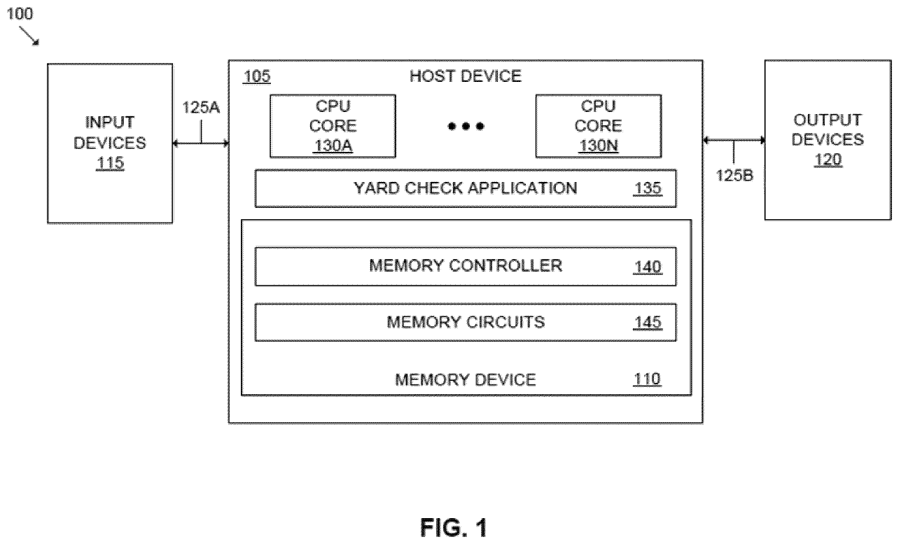

Referring now to FIG. 1, an example block diagram of a computing system 100 is shown, in accordance with some embodiments of the present disclosure. The computing system 100 includes a host device 105. The host device 105 includes a memory device 110. In other embodiments, the memory device 110 associated with the host device 105 is a separate device that is communicatively coupled to the host device 105 instead. The host device 105 may be configured to receive input from one or more input devices 115 and provide output to one or more output devices 120. The host device 105 may be configured to communicate with the input devices 115 and the output devices 120 via appropriate interfaces or channels 125A and 125B, respectively. The computing system 100 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 105.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 100) may be implemented by multiple computing devices in a distributed environment, and vice versa. In some embodiments, the computing system 100 or at least some of the features described herein may be implemented in an in-vehicle system (e.g., tablet) that may be configured to implement at least some of the functions described herein and report those out to a server while, in other embodiments, the server may perform the functions.

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, camera, and any other input peripheral that is associated with the host device 105 and that allows an external source, such as a user, to enter information (e.g., data) into the host device and send instructions to the host device 105. Similarly, the output devices 120 may include a variety of output technologies such as external memories, printers, speakers, displays, microphones, light emitting diodes, headphones, plotters, speech generating devices, video devices, global positioning systems, and any other output peripherals that are configured to receive information (e.g., data) from the host device 105. The “data” that is either input into the host device 105 and/or output from the host device may include any of a variety of textual data, graphical data, video data, image data, sound data, position data, sensor data, combinations thereof, or other types of analog and/or digital data that is suitable for processing using the computing system 100.

The host device 105 may include one or more Central Processing Unit (“CPU”) cores or processors 130A-130N that may be configured to execute instructions for running one or more applications associated with the host device 105. In some embodiments, the instructions and data needed to run the one or more applications may be stored within the memory device 110. The host device 105 may also be configured to store the results of running the one or more applications within the memory device 110. One such application on the host device 105 may include a yard check application 135. The yard check application 135 may be executed by one or more of the CPU cores 130A-130N. The instructions to execute the yard check application 135 may be stored within the memory device 110. The yard check application 135 is described in greater detail below. Thus, the host device 105 may be configured to request the memory device 110 to perform a variety of operations. For example, the host device 105 may request the memory device 110 to read data, write data, update or delete data, and/or perform management or other operations.

To facilitate communication with the memory device 110, the memory device 110 may include or be associated with a memory controller 140. Although the memory controller 140 is shown as being part of the memory device 110, in some embodiments, the memory controller 140 may instead be part of another element of the computing system 100 and operatively associated with the memory device 110. For example, when the memory device 110 is a separate device from the host device 105, the memory controller 140 may be configured as a logical block or circuitry that receives instructions from the host device 105 and performs operations in accordance with those instructions. For example, when the execution of the yard check application 135 is desired, the host device 105 may send a request to the memory controller 140. The memory controller 140 may read the instructions associated with the yard check application 135 that are stored within the memory device 110, and send those instructions back to the host device 105. Continuing with the example embodiment of the memory device 110 being a separate device from the host device 105, those instructions may be temporarily stored within a memory on the host device 105. One or more of the CPU cores 130A-130N may then execute those instructions by performing one or more operations called for by those instructions of the yard check application 135.

The memory device 110 may include one or more memory circuits 145 that store data and instructions. The memory circuits 145 may be any of a variety of memory types, including a variety of volatile memories, non-volatile memories, or a combination thereof. For example, in some embodiments, one or more of the memory circuits 145 or portions thereof may include NAND flash memory cores. In other embodiments, one or more of the memory circuits 145 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 110. In some embodiments, one or more of the memory circuits 145 or portions thereof may be configured as other types of storage class memory (“SCM”). Generally speaking, the memory circuits 145 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110, including the memory controller 140 and the memory circuits 145, may include hardware, software, and/or firmware components that are considered necessary or desirable in performing the functions described herein. In addition, in certain embodiments, the memory device 110 may integrate some or all of the components of the host device 105, including, for example, the CPU cores 130A-130N, and the CPU cores may be configured to execute the yard check application 135, as described herein.

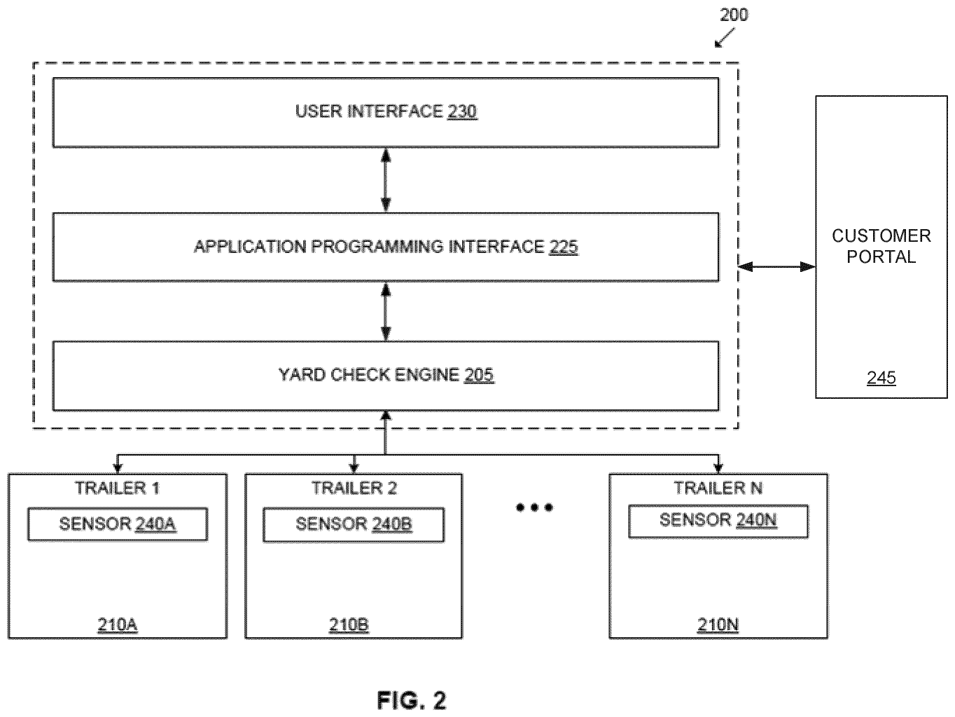

Turning now to FIG. 2, an example yard check application 200 is shown, in accordance with some embodiments of the present disclosure. The yard check application 200 is an example implementation of the yard check application 135 of FIG. 1. Thus, although not shown, the yard check application 200 may be associated with a host device (e.g., the host device 105) and other elements described above in FIG. 1. The yard check application 200 may be used to track location and/or status of one or more trailers via a yard check engine 205 based upon sensor data received from one or more trailers 210A-210N (collectively referred to herein as “trailers 210”)). The yard check engine 205 may also be used to perform one or more actions based upon the determined location and/or status of the trailers 210, as well as based on information received from a customer, as discussed in greater detail below.

The yard check application 200 may also include a user interface 230 that serves as the front end of the yard check application. In some embodiments, the yard check engine 205 may be accessed through the user interface 230 via an Application Programming Interface (“API”) 225. Specifically, to access the yard check engine 205 via the user interface 230 using the API 225, a user may use designated devices such as laptops, desktops, tablets, mobile devices, other handheld or portable devices, and/or other types of computing devices that are configured to access the API 225. In some embodiments, these devices may be different from the computing device on which the yard check application 200 is installed. In other embodiments, the yard check application 200 may be hosted on a cloud service and may be accessed through the cloud via a web or mobile application.

In some embodiments, the user may access the user interface 230/the yard check engine 205 via a web browser, upon entering a uniform resource locator (“URL”) for the API 225 such as the IP address of the yard check application 200 or other designated web address. In some embodiments, the user interface 230/the yard check engine 205 may be accessed via a mobile application downloaded to a mobile device. In other embodiments, the user interface 230/the yard check engine 205 may be configured for access in other ways. In some embodiments, a user of the yard check application 200 may be a provider of the yard check application or any personnel/entity to whom the provider makes the yard check application accessible. For example, in some embodiments, the user may be a provider of trailers, containers, or other storage equipment that may be used to ship cargo from one point to another. In other embodiments, the user may be a customer that uses those trailers, containers, etc. for shipment of their cargo. Generally speaking, the user of the yard check application 200 may be any personnel, company, or entity that may be interested at least in performing the functions described herein. It is to be understood that, while the present disclosure has been described with respect to the trailers 210, the present disclosure may also be applicable to other applications where real-time and accurate managing of a fleet is desired.

Further, upon accessing the user interface 230/the yard check engine 205, users may send instructions or queries to the yard check engine 205 and receive information back from the yard check engine via the user interface 230. Thus, the user interface 230 facilitates human-computer interaction between the users and the yard check engine 205. In some embodiments, the user interface 230 may present a graphical user interface (“GUI”) to a user to receive input from and provide output to the user. The GUI may present a variety of graphical icons, windows, visual indicators, menus, visual widgets, and other indicia to facilitate user interaction. In other embodiments, the user interface 230 may be configured as other types of user interfaces. Further, the user interface 230 may be configured to receive user inputs in a variety of ways. In some embodiments, the user interface 230 may be configured to receive user inputs via the input devices 115. In other embodiments, the user interface 230 may be configured to receive the user inputs in other ways. The user interface 230 may also be configured to present outputs/information to the users in a variety of ways. In some embodiments, the user interface 230 may present outputs to the user via the output devices 120. In other embodiments, the user interface 230 may be configured to present the outputs in other ways (e.g., audible, tactile, or visual alarms, etc.). Generally speaking, the user interface 230 may be associated with any type of hardware, software, and/or firmware component that enables the yard check application 200 to perform the functions described herein.

Further, in some embodiments, the API 225 that is used to communicate with the yard check engine 205 via the user interface 230 may be a representational state transfer (“REST”) type of API. In other embodiments, the API 225 may be any other type of web or other type of API (e.g., ASP.NET) built using any of a variety of technologies, such as Java, .Net, etc., that is suitable for facilitating communication between the yard check engine 205 and the users via the user interface 230. In some embodiments, the API 225 may be configured to facilitate communication via a hypertext transfer protocol (“HTTP”) or hypertext transfer protocol secure (“HTTPS”) type request. The API 225 may receive an HTTP/HTTPS request and send an HTTP/HTTPS response back. In other embodiments, the API 225 may be configured to facilitate communication using other or additional types of communication protocols.

It is to be understood that only some components of the yard check application 200 are shown and described in FIG. 2. However, the yard check application 200, including the yard check engine 205, may include or be associated with any of a variety of hardware, software, and/or firmware components that are needed or considered desirable in performing the functions described herein.

Referring still to FIG. 2 and as indicated above, the yard check engine 205 receives input from the trailers 210. In some embodiments, each of the trailers 210 may be a storage container or other types of nonautomotive wagon, box, or the like configured to be attached to a transportation vehicle for hauling freight from one destination to another. The shape, size, and other configuration details of each of the trailers 210 may vary from one embodiment to another. Further, the type of transportation vehicle to which the trailers 210 are attached may vary from one embodiment to another. For example, in some embodiments, the trailers 210 may be configured for transportation by road or rail. In other embodiments, the trailers 210 may additionally or alternatively be configured for transportation by water, air, or any other suitable modes of transportation. In some embodiments, the trailers 210 may be configured for transportation by a single mode of transportation. In other embodiments, the trailers 210 may be configured for intermodal transportation. Further, in some embodiments, each of the trailers 210 may be associated with a trailer type, a trailer location, a customer site location, a trailer identifier (e.g., a trailer identifier number and/or keyword), a trailer status, and/or any other information that may be considered necessary or desirable to have in identifying a trailer, the location and status of that trailer, the cargo that is carried or intended to be carried within that trailer, etc.

Additionally, in some embodiments, the trailers 210 may be located on a yard (e.g., of a customer) in between travel or for loading, maintenance, etc., or en-route. As described herein, a “yard” may refer to any area or site where a trailer may be parked for cargo loading and/or unloading, maintenance, or generally between travel. In some embodiments, each yard may be associated with a geo-fence area. In some embodiments, the geo-fence area of the yard may be provided as an input (e.g., as location coordinates (e.g., latitude and longitude coordinates)) to the yard check application 200 to enable the yard check engine 205 to identify a current location of the trailers 210. For example, if the yard check engine 205 determines that a trailer is within a geo-fenced area, the yard check engine may determine that the trailer is located on the yard. If the trailer is outside of the geo-fenced area, the yard check engine 205 may determine that the trailer is not on the yard. In some embodiments, the trailers 210 may all be located on a single yard. In other embodiments, the trailers 210 may be spread across multiple yard sites.

Further, in some embodiments, each of the trailers 210 is equipped with one or more sensors. For example and as shown in FIG. 2, in some embodiments, the trailer 210A may be equipped with a sensor 240A, the trailer 210B may be equipped with a sensor 240B, and so on. Although each of the trailers 210 is shown as having a single sensor, in other embodiments, one or more of those trailers may have multiple sensors. Further, the type of sensor or sensors on each of the trailers 210 may vary from one embodiment to another. For example, in some embodiments, one or more of the sensors 240A-240N (collectively referred to herein as “sensors 240”) may include temperature sensors, audio sensors, pressure sensors, inertial sensors such as accelerometers, light detection and illumination sensors, motion sensors, proximity sensors such as inductive, capacitive, ultrasonic, or photoelectric sensors, location sensors such as global positioning system (GPS) sensors, camera systems, video camera systems, lighting systems, and/or any other type of sensor(s) that may be used to determine the status and/or location of a trailer, the type of cargo within a trailer, and any other information that is desirable to collect from the trailers 210. The data collected by the sensors 240 may be utilized by the yard check engine 205 to determine a location and/or current status of the trailers 210. The sensors 240 may also be used to determine a type of cargo stored within the trailers 210.

Additionally, the location of the sensors 240 on the trailers 210 may vary from one embodiment to another. In some embodiments, the sensors 240 may be installed in the interior of the trailers 210 to generate sensor data regarding the inside of those trailers. For example, one or more cameras may be installed on the interior of the trailers 210 to take images of any cargo stored within those trailers. The cameras installed on the interior of the trailers 210 may also be used to determine whether the trailers are empty or loaded. Similarly, in some embodiments, other types of sensors may be installed on the interior of the trailers 210 to gather desired information from the interior of those trailers. In other embodiments, the sensors 240 may additionally or alternatively be installed on the exterior of the trailers 210. For example, cameras may be installed on the outside of the trailers 210 to collect image data of the areas surrounding the trailers. GPS sensors may also be installed on the exterior of the trailers 210. The location where the sensors 240 are installed on the interior and/or the exterior of the trailers 210 may vary from one embodiment to another. In some embodiments, the trailers 210, including the sensors 240, may form part of an internet of things (IoT) network that communicates data with the yard check engine 205 to monitor the trailers.

The sensors 240 may be configured to collect sensor data from the trailers 210 to which those sensors are mounted to. In some embodiments, the sensors 240 may be configured to collect sensor data continuously, while in other embodiments, the sensors 240 may be configured to collect data periodically. In some embodiments, the sensors 240 may be configured to store temporarily upon collection and/or transmit data periodically. In other embodiments, the sensors 240 may be configured to transmit the collected sensor data instantaneously or substantially instantaneously. Further, in some embodiments, the sensors 240 may be configured to communicate (e.g., to transmit the collected sensor data, to receive instructions, updates, etc. from the yard check engine 205, etc.) with the yard check engine 205 through one or more gateways or other suitable mechanisms. In some embodiments, one or more of the sensors 240 may also be configured to communicate with other sensors on the same trailer and/or with the sensors on other ones of the trailers 210. In some embodiments, the sensors 240 may be configured to communicate with other or additional components of the yard check application 200.

Additionally, in some embodiments, the sensors 240 may be configured to communicate (either with the yard check engine 205, other sensors, or any other component with which the sensors communicate with) using communication links including wired and/or wireless communication links such as jacks, antennas, transmitters, receivers, transceivers, wire terminals, electrical cables, connectors, network interfaces, switches, routers, etc. using communication protocols and channels such as TCP/INPUT, BACnet INPUT, BACnet MSTP, CAN Modbus, USB, Firewire, UART, SPI, RS-485, PSTN, Wi-Max, Bluetooth, LoRa, NFC, Zigbee, cellular or mobile phone communication channels (e.g., cellular 5G), wireless radio channels, local area network, metropolitan area network, wide area network, world wide web, internet, Ethernet, etc.

The yard check engine 205, upon receiving the sensor data, may store the sensor data from the sensors 240 within a memory (e.g., memory device 110). In some embodiments, the yard check engine 205 may be configured to store the sensor data indefinitely, while in other embodiments, the yard check engine may store the sensor data for a designated period of time before deleting that data. The yard check engine 205 may utilize the sensor data to perform one or more actions, as discussed below.

In some embodiments, the yard check application 200 may be configured to interface with a customer portal 245 of a customer that uses the trailers 210 for shipment of their cargo. In some embodiments, the customer portal 245 may be a separate application from the yard check application 200. The yard check application 200 may be configured to interface with the customer portal 245 to receive information from the customer portal and provide information to the customer portal. In other embodiments, the customer portal 245 may be part of the yard check application. Thus, in some embodiments, although shown separate from the yard check application 200, the customer portal 245 may be incorporated into the yard check application. In some embodiments, the customer portal 245 may be an order management system of the customer that is configured to manage the orders of the customer. For example, in some embodiments, the order management system may be used to create new orders, manage (view, modify, delete) existing or open orders, manage past orders, etc. Generally speaking, the order management system may enable the customer to track and manage sales, orders, and inventory of freight.

By integrating the customer portal 245 with the yard check application 200, the present disclosure provides an easy, convenient, and effective mechanism to the customer for managing the customer's trailers. For example, by integrating the customer portal 245 with the yard check application 200, a customer can easily assign a trailer to a new order, request maintenance of their existing trailers, view the current status of their current trailers, plan for future need in terms of the number of trailers that may be needed, etc. Similarly, by integrating the customer portal 245 with the yard check application 200, the yard check application may be able to provide a more accurate status of the customer's trailers, update or change status based on order information, manage maintenance of the fleet of transport vehicles that haul the trailers 210, manage pick up and drop off of the trailers at the customer site, etc.

Although not shown, the customer portal 245 may include a user interface similar to the user interface 230 to allow the customer to interact with the yard check application 200, one or more processing units (e.g., similar to the CPU cores 130A-130N), a memory device (e.g., similar to the memory device 110), and/or any other software, hardware, firmware, or combinations thereof that may be needed to perform the functions described herein.

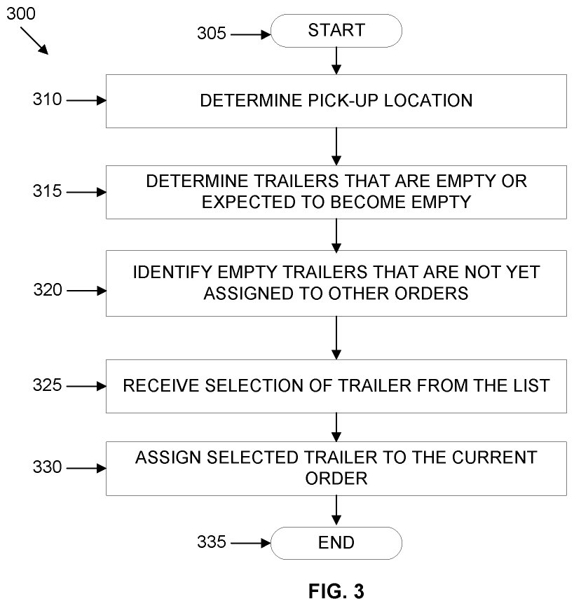

Referring now to FIG. 3, a flowchart outlining operations of a process 300 is shown, in accordance with some embodiments of the present disclosure. In some embodiments, the process 300 may be implemented via the yard check engine 205 of the yard check application 200. The process 300 may be used to assign a trailer to a current order. For example, in some embodiments, the process 300 may be used to assign a trailer to a current order that does not have a trailer assigned thereto already. In other embodiments, the process 300 may be used to assign another trailer (e.g., change the assignment, add another trailer, etc.) to the current order.

Generally, a customer may have a multiple trailers to ship their freight. Some trailers may already be allocated to orders, while other may be sitting empty waiting for an order assignment. When a customer wants to assign an empty trailer to an order, the customer first needs to identify the trailers that are empty. Without access to the yard check application 200, the customer may identify empty trailers by having a person walking around the yard and opening each trailer to see which trailers are empty. In some cases, the customer may not have any empty trailers on the yard. In such cases, the customer may need to wait for a loaded trailer to be unloaded and become empty or wait for another trailer to be delivered to the customer's yard. Both of these options may take time, and depending upon the urgency of the order, these options may not be practical or desired.

In some cases, the customer may have access to the yard check application 200 that maintains a current status of each of customer's trailers, but the yard check application may not be integrated with (e.g., does not receive information from) the customer's order management system. In such cases, to assign a trailer to an order created in the customer's order management system, the customer may need to separately access the yard check application 200 to determine the current statuses of each of the customer's trailers and identify the empty trailers on the yard. Upon identifying an empty trailer, the customer may need to go back to the order management system and assign the identified empty trailer to the order. In some cases, between the time the empty trailer is identified on the yard check application 200 and the empty trailer is assigned to the order on the order management system, the status of that trailer may change. For example, that trailer may get assigned to another order requiring the customer to go back to the yard check application 200 and identify another empty trailer. Thus, while having separate systems for the order management system and the yard check application 200 is an improvement over not having the yard check application, greater benefits may be had by integrating the yard check application with the customer's order management system. Particularly, in some embodiments, by integrating the customer's order management system (e.g., the customer portal 245) with the yard check application 200, the customer may easily and conveniently assign a trailer to an order via the customer portal.

Thus, the process 300 starts at operation 305 when the customer desires to assign a trailer to a current order. In some embodiments, the customer may open the order details of the current order to which a trailer is to be assigned on the customer portal 245 and interact with (e.g., click on) an “assign trailer to order” or “assign empty trailer,” or the like option available to assign a trailer to an order. In other embodiments, the customer portal 245 may be configured to assign a trailer to the current order in other ways. Upon receiving an indication from the customer portal 245 to assign a trailer to the current order, at operation 305, the yard check application 200, and particularly, the yard check engine 205 of the yard check application, may identify a pick-up location of the current order at operation 310. For example, in some embodiments, the yard check engine 205 may retrieve the current order details and determine the location of the yard from where the current order is to ship (referred to herein as “pick-up location”). At operation 315, the yard check engine 205 may determine a pool of trailers allocated to the customer that are empty and located at the pick-up location.

A trailer may have the status of “empty” if that trailer has no cargo loaded therein or if the trailer has no cargo loaded in greater than a predetermined percentage of the volume of the trailer. The term “status” may describe a current condition of the trailers 210. For example, the “status” may include whether the trailer is inbound or outbound, whether the trailer is empty or loaded, whether the trailer is located on a yard or en-route, location of the trailer on the yard, location of the trailer en-route, and so on.

In some embodiments, the yard check engine 205 may identify the trailers 210 having the current status of empty based upon either the sensor data from the sensors 240, customer feedback, or both. For example, based on global positioning data obtained from the trailers 210 and comparing that data with the location coordinates of the pick-up location, the yard check engine may determine the current location of the trailers to identify the trailers that are located at the pick-up location. The yard check engine 205 may then determine the current status of each of the trailers 210 that are at the pick-up location to identify the empty trailers. In some embodiments, the yard check engine 205 may determine the current status of the trailers 210 by analyzing the sensor data using machine learning or artificial intelligence algorithms. In other embodiments, the yard check engine 205 may use image processing techniques to compare sensor data (e.g., an image from an infrared camera, an image from an external camera mounted on a nearby building, etc.) to a baseline image of the trailers. In yet other embodiments, the yard check engine 205 may use a combination of machine learning/artificial intelligence algorithms and image processing to determine the status of the trailers 210. In other embodiments, the yard check engine 205 may determine whether the trailers 210 that are empty by analyzing sensor data from proximity and/or pressure sensors within the trailers.

In some embodiments, the yard check engine 205 may receive the customer feedback indicating the current status of the trailers 210. For example, in some embodiments, the customer feedback may indicate whether a particular trailer of the trailers 210 has been loaded or unloaded. In some embodiments, the customer feedback may also indicate whether a particular trailer of the trailers 210 has departed the yard or has arrived at the yard. In other embodiments, the customer feedback may include other types of information associated with the trailers 210 that may be beneficial for the yard check engine 205 to have in identifying the trailers 210 that are empty. In other embodiments, the yard check engine 205 may use mechanisms other than, or in addition to, the sensor data and the customer feedback to identify the trailers 210 that are empty. Additional details for identifying the trailer statuses and determining which trailers are empty may be found in U.S. non-provisional patent application having Attorney Docket. No. 124715-0104, the entirety of which is incorporated by reference herein.

Upon receiving the customer feedback, the yard check engine 205 may update the pool of empty trailers. For example, in some embodiments, the yard check engine 205 may create a first pool of empty trailers based upon the sensor data. Upon receiving the customer feedback, the yard check engine 205 may update the first pool to create a second pool. For example, if the customer feedback indicates that a particular trailer has been loaded now, the yard check engine 205 may update the first pool to remove that particular trailer from the first pool. Thus, by using the customer feedback, the yard check engine 205 is able to create an accurate pool of empty trailers. Similarly, if the customer feedback indicates that a particular trailer is now empty, the yard check engine 205 may update the first pool to include the particular trailer.

In some embodiments, in addition to identifying the empty trailers (e.g., the trailers 210 that have a current status of empty) at the pick-up location, the yard check engine 205 may also identify the trailers that are at the pick-up location, are not currently empty, but are expected to become empty soon (e.g., within a predetermined time period). For example, the yard check engine 205 may determine the date by when the current order is to be ship (referred to herein as “ship date”). In some embodiments, the yard check engine 205 may determine the ship date based on order details and/or based on customer feedback (e.g., the customer feedback may indicate the ship date). The yard check engine 205 may then identify those ones of the trailers 210 that are expected to become empty by a predetermined date/time before the ship date. For example, in some embodiments, if the current order is to be shipped on Saturday, then the yard check engine 205 may identify all trailers that would become empty at least two days before Saturday to ensure time to load the trailer again and ship the current order by Saturday. The number of days or time before the current order ship date that the yard check engine 205 uses for identifying the trailers 210 that are expected to become empty may be dependent upon a variety of factors.

For example, in some embodiments, the yard check engine 205 may determine (e.g., from order details and/or customer feedback) how soon before the current order is to ship, the trailer would need to be empty depending upon the type of freight that is to be shipped. For example, in some embodiments, the yard check engine 205 may determine that some types of freight require longer to load than other types of freight. In other embodiments, the yard check engine 205 may be programmed with other factors to determine how far in advance of the order ship date a trailer would have to be empty to enable the order to ship by the ship date.

In some embodiments, the yard check engine 205 may identify the trailers 210 that are expected to become empty based on the current status of those trailers. For example, in some embodiments, a trailer may have a status of “inbound loaded” if that trailer has arrived at the yard (e.g., the pick-up location) with loaded cargo for delivery at that yard, but has not been unloaded yet. The yard check engine 205 may further determine if the customer has provided any feedback on when a trailer having the status of “inbound loaded” would be unloaded. For example, if the customer provided feedback to the yard check application 200 indicating that a trailer is expected to be unloaded starting on Date A, the yard check engine 205 may determine that the trailer may become empty either on Date A or Date B that is after Date A based upon the type of freight that is being unloaded. In some cases, a particular type of freight may take longer to unload than others. If the Date A or Date B is at least the predetermined number of days before the current order ship date, the yard check engine 205 may determine that the trailer may become available to be assigned to the order. Thus, in some embodiments, based upon the customer feedback, the yard check engine 205 may identify that a certain trailer having a current status of inbound loaded may become empty soon.

In other embodiments, the yard check engine 205 may determine that a particular trailer is not at the yard (e.g., at the pick-up location), but is expected to reach the yard soon. For example, in some embodiments, the yard check engine 205 may determine a current location of the trailers 210 that are currently en-route to the yard. In some embodiments, the yard check engine 205 may identify the trailers that are currently en-route to the yard based upon current location coordinates of the trailer, the general direction in which the trailer is headed (e.g., by comparing two location coordinates taken some time apart, by looking at the order details indicating where the trailer is headed, etc.), and/or the order details associated with those trailers. For example, if the yard check engine 205 determines that trailer A is currently en-route, the yard check engine may retrieve the order details or other information related to trailer A to determine that the trailer is expected to reach the yard on Date A. The yard check engine 205 may then determine that the trailer would be unloaded by Date B based upon the type of freight, etc., as discussed above. The yard check engine 205 may also determine that Date B is at least a predetermined number of days before the order ship date. Thus, the yard check engine 205 may conclude that trailer A is expected to become empty soon and may potentially be assigned to the order.

In some embodiments, the yard check engine 205 may also identify any trailers that are located on neighboring yards and may quickly be delivered to the pick-input location, and include those trailers in the pool of empty trailers. For example, if the yard check engine 205 finds no empty trailers at the pick-up location or trailers that are en-route to the yard, the yard check engine may determine if there are empty trailers on neighboring yards that may be delivered. The yard check engine 205 may use other mechanisms to identify the trailers 210 that are expected to become empty soon. Thus, at the operation 315, the yard check engine 205 determines a pool of empty trailers at the yard or expected to become empty at the yard.

In the discussion below, trailers that are empty or expected to become empty are both simply referred to as trailers that are empty for ease of explanation. Thus, in the discussion below, when a trailer is referred to as empty, that reference includes both, trailers that are empty and trailers that are expected to become empty.

Upon identifying the pool of the trailers 210 that are empty at the pick-up location, at operation 320, the yard check engine 205 identifies those empty trailers that are not currently assigned to other orders. In some embodiments, once an empty trailer is assigned to an order, the status of that trailer may be changed from empty to another status, such as “outbound,” “assigned,” “allocated,” etc. In such embodiments, the operation 320 may be optional since the yard check engine 205 may assume that if the current status of a trailer is empty, that trailer is available for assigning to an order. In some such embodiments in which the current status of a trailer is not changed upon being assigned to an order, an indication (e.g., a notation) may be made against the trailer and/or order that the trailer has been assigned to the order but the official status of the trailer may remain “empty” until cargo is actually loaded into that trailer. In such cases, the yard check engine 205 may determine (e.g., by cross-referencing the customer portal 245) if a particular trailer has been assigned to another order at the operation 320. Any trailer that has already been assigned to another order may be considered unavailable for the current order and removed from the pool of empty trailers. Thus, at the operation 320, the yard check engine 205 identifies all the trailers 210 that are empty, that are not yet assigned to another order, and that are located at the pick-up location or could become available at the pick-up location in time for the order to be loaded and shipped by the ship date.

Although the operation 320 is described as being performed after the operations 310 and 315, in some embodiments, the operations 310-320 may be performed in any order with the goal being to identify a list of the trailers 210 that are empty, not assigned to another order, and are located at the pick-up location or expected to become available at the pick-up location. Further, in some embodiments, the yard check engine 205 may continue to update the list continuously or periodically in real-time until a trailer has been assigned to the order. By updating the list in real-time or substantial real-time, the yard check engine 205 avoids the possibility of assigning one trailer to multiple orders. For example, if trailer A appears on the list at Time A, and that trailer is assigned to another order before a trailer selection is received for the current order, the yard check engine 205 may remove trailer A from the list to prevent inadvertent assignment of trailer A to the current order. The yard check engine 205 may present the list of the trailers 210 that are empty, not assigned to another order, and are located at the pick-up location or expected to become available at the pick-up location on the customer portal 245.

At operation 325, the yard check engine 205 receives a selection of one or more trailers from the list presented on the customer portal 245, and at operation 330, the yard check engine assigns the selected trailer to the current order. To assign the selected trailer to the current order, in some embodiments, the yard check engine 205 may update the status of the selected trailer such that the status of the selected trailer does not appear as “empty” anymore. For example, in some embodiments, the yard check engine 205 may change the status of the selected trailer to “outbound.” In some embodiments, a trailer may have a status as “outbound” if the trailer has been designated to depart from the yard (even though the trailer may not have been loaded yet). In other embodiments, the yard check engine 205 may change the status from empty to another designated status. In some embodiments, in addition to or instead of changing the status, the yard check engine 205 may make an indication against the selected trailer/order that the trailer has been assigned to an order to prevent the trailer from being assigned to another order. In some embodiments, the assigned trailer may be added to the order details for personnel to know which trailer has been assigned to that order. In some embodiments, the yard check engine 205 may perform other or additional actions to indicate that the selected trailer has been assigned to the order. Upon assignment, the selected trailer is removed from the pool or list of trailers compiled by the yard check engine 205 at the operation 320. The process 300 ends at operation 335 waiting for another assignment.

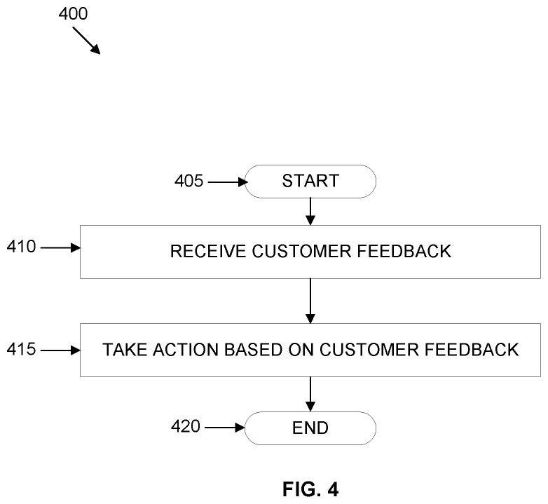

Turning now to FIG. 4, an example flowchart outlining a process 400 is shown, in accordance with some embodiments of the present disclosure. The process 400 may be implemented by the yard check engine 205 of the yard check application 200. The process 400 may be used to take action based upon customer feedback. In some embodiments, the yard check engine 205 may augment or update current status of the trailers 210 based upon customer feedback, as discussed in the U.S. Non-Provisional Application having the Attorney Docket No. of 124715-0104 mentioned above. In addition to augmenting or updating the current status of the trailers 210 based upon customer feedback, in some embodiments, the yard check engine 205 may take additional actions, as discussed below.

Thus, upon starting at operation 405, the yard check engine 205 receives customer feedback at operation 410 about one or more of the trailers 210. In some embodiments, the customer feedback may be sent via the customer portal 245 to the yard check engine 205. In other embodiments, the customer feedback may be sent to the yard check engine 205 via other mechanisms. In some embodiments, the customer feedback may be manually input into the customer portal 245 for sending to the yard check engine 205. In other embodiments, the customer portal 245 may automatically send customer feedback when a certain condition associated with a particular trailer changes or when any changes to a particular order to which the particular trailer is assigned is made.

Customer feedback may include information related to the trailers 210. For example, in some embodiments, the customer feedback may include information about a current status of the trailers 210. In some embodiments, the customer feedback may include an indication that a particular trailer that was previously empty has now been loaded. Similarly, in some embodiments, the customer feedback may include an indication that a particular trailer that was previously loaded is now empty. In other embodiments, the customer feedback may include an indication that a particular trailer has arrived at the yard, has departed the yard, has been designated to be loaded or unloaded at a future time, etc. The customer feedback may include other types of information pertaining to the trailers 210. Further, in some embodiments, the customer feedback may be sent continuously as soon as new information impacting a particular trailer is available, while in other embodiments, the customer feedback may be sent periodically (e.g., every few seconds, minutes, hours, etc.).

Upon receiving the customer feedback, the yard check engine 205 takes one or more actions based upon the customer feedback at operation 415. For example, based upon the customer feedback, the yard check engine 205 may update the current status of one or more of the trailers 210, as discussed above. In some embodiments, based upon the customer feedback, the yard check engine 205 may also update the pool of empty trailers that is compiled at the operations 310-320 for assigning a trailer to an order, as discussed in greater detail below. In some embodiments, the yard check engine 205 may also use the customer feedback to manage the fleet of transport vehicles that haul the trailers 210 for the customer from one location to another. The yard check engine 205 may also store the customer feedback within the memory device 110. The process 400 ends at operation 420 waiting for the next set of customer feedback.

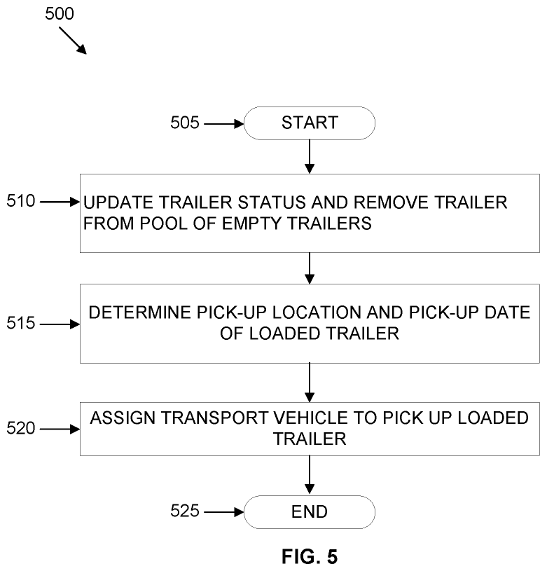

Referring now to FIG. 5, an example flowchart outlining a process 500 is shown, in accordance with some embodiments of the present disclosure. The process 500 may be implemented by the yard check engine 205 of the yard check application 200. The process 500 may be used to manage a fleet of transport vehicles based upon customer feedback indicating that a trailer is loaded or about to be loaded. In particular, the process 500 may be configured to implement what may be referred to as a “pick-up now” feature by which a customer may request that a trailer that is ready to depart from the yard or will be ready to depart from the yard soon be picked up by a transport vehicle. For example, in some embodiments, the customer may create a new order. The customer may then assign an empty trailer to the order via the process 300 discussed above. Upon assigning the trailer, the customer may either load the assigned trailer with cargo to be shipped or determine an appropriate day/time for loading the trailer. Upon loading the cargo or designating a day/time for the cargo to be loaded, the customer may, via the customer portal 245, send an indication to the yard check engine 205 that the trailer is ready to be picked up or will be ready to be picked up based on the designated loading day/time.

The process 500 is explained with respect to the trailer 210A. However, the process 500 is equally applicable to the trailers 210B-210N also. Thus, the process 500 starts at operation 505 with the receiving of customer feedback indicating that the trailer 210A has been loaded or is designated to be loaded at a given future time. In some embodiments, the customer feedback may also provide a particular date when the customer would like the trailer to be picked up. For example, in some embodiments, the customer feedback may indicate that the trailer 210A is loaded, but that the customer would like the trailer to be picked up on Date A, which in some embodiments, may be after the date the trailer was loaded.

Upon receiving the customer feedback that the trailer 210A is loaded or is designated to be loaded, the yard check engine 205, at operation 510, updates the current status of that trailer to indicate that the trailer is “loaded” and removes that trailer from the pool of empty trailers compiled at the operations 310-320. A trailer may have a status of “loaded” if that trailer is carrying at least some cargo or if that trailer has cargo loaded in greater than a predetermined percentage of the volume of that trailer. In some embodiments, when the customer feedback indicates that the trailer 210A is designated to be loaded but is not actually loaded right now, the yard check engine 205 may remove the trailer from the pool of empty trailers compiled at the operations 310-320, but may maintain the status of that trailer as “empty” until that trailer is actually loaded. In addition, at operation 515, the yard check engine 205 may schedule a pick-up of the trailer 210A for transporting the trailer from the pick-up location to the destination.

Thus, at the operation 515, the yard check engine 205 may retrieve order details associated with the trailer 210A. In some embodiments, the yard check engine 205 may determine the pick-up location of the trailer 210A from the order details. In some embodiments, the yard check engine 205 may identify any other information from the order details that may be needed or considered desirable to have in scheduling a pick-up of the trailer 210A. At operation 520, upon determining the pick-up location, the yard check engine 205 may assign a transport vehicle to pick-up the trailer 210A to transport the cargo. To the extent that the type of the trailer 210A may impact the type of the transport vehicle needed to haul that trailer, in some embodiments, the yard check engine 205 may determine the type of the trailer 210A. For example, in some embodiments, the yard check engine 205 may identify whether the trailer 210A is an intermodal type of trailer, a flatbed trailer, a refrigerated type of trailer, deck trailer, etc. In some embodiments, the yard check engine 205 may also determine the size of the trailer and any additional details that may impact the type of the transport vehicle assigned to haul the trailer.

The yard check engine 205 may also determine a list of transport vehicles that are available or are expected to become available to pick-up the trailer 210A from the pick-up location at the pick-up date, and transport the trailer to the destination. In some embodiments, if the customer feedback identifies a specific date for picking up the trailer 210A, that specific date may be the pick-up date. In other embodiments, the customer feedback may not specifically mention a date, but may indicate that the trailer 210A is ready to pick up or will be ready to pick up at Date A (e.g., will be loaded by Date A). In such cases, the Date A may be the pick-up date or the pick-up date may be within a predetermined number of days upon receiving the customer feedback. Thus, the yard check engine 205 also determines the pick-up date for picking up the trailer 210A.

In some embodiments, the yard check engine 205 may review the list of available transport vehicles and their respective travel schedules to identify a suitable transport vehicle for picking up the trailer 210A from the pick-up location. For example, in some embodiments, the yard check engine 205 may determine that a transport vehicle dropped off an order at the pick-up location or another location close to the customer's yard, and is not scheduled to pick-up another order. So, the yard check engine 205 may allocate that transport vehicle to pick-up the trailer 210A. In other embodiments, the yard check engine 205 may pick a transport vehicle that is available at or near the pick-up location and the transport is configured to pick up another order from a location that is close to the destination of the current order. In some embodiments, the yard check engine 205 may consider the working schedules of the drivers driving the transport vehicles to identify an appropriate transport vehicle to pick up the order from the pick-up location. For example, in some embodiments, if the yard check engine 205 identifies a transport vehicle whose driver resides at or close to the destination location and is available or will be available to pick up the order from the pick-up location, the yard check engine may assign that transport vehicle to the order. In other embodiments, the yard check engine 205 may consider additional or other criteria in picking an appropriate transport vehicle for the order.

Upon identifying a suitable transport vehicle to pick up the order, the yard check engine 205 may assign that transport vehicle to the order at operation 520 and the process 500 ends at operation 525. By integrating the customer portal 245 with the yard check application 200, and by enabling the customer to request a pick-up of the loaded or to be loaded trailer directly through the customer portal, the present disclosure provides an easy and convenient mechanism to schedule order pick-ups.

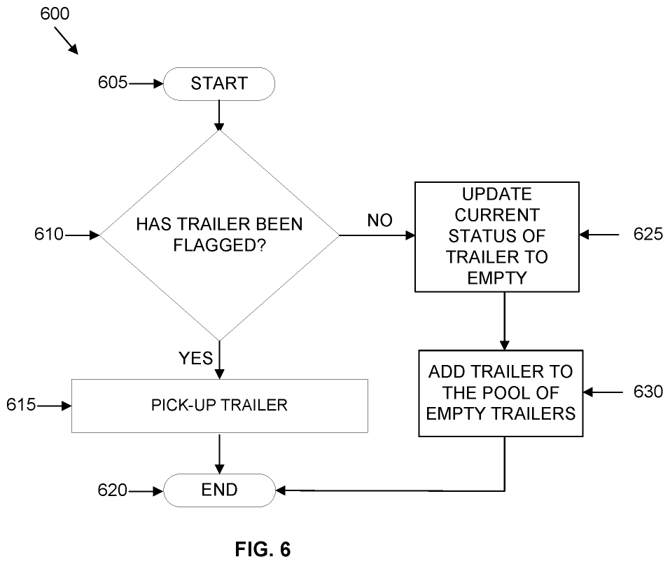

Turning now to FIG. 6, an example flowchart outlining a process 600 is shown, in accordance with some embodiments of the present disclosure. The process 600 may be implemented by the yard check application 200. The process 600 may be used to manage the trailers 210 of the customer based upon customer feedback indicating that a trailer is unloaded or about to be unloaded. The process 600 is explained with respect to the trailer 210A. However, the process 600 is equally applicable to the trailers 210B-210N also. Thus, the process 600 starts at operation 605 with the receiving of customer feedback indicating that the trailer 210A has been unloaded or is designated to be unloaded at a given future time.

Upon receiving the customer feedback that the trailer 210A has been unloaded or is designated to be unloaded, the yard check engine 205 may determine, at operation 610, whether the trailer has been flagged for any reason. In some embodiments, a trailer may be flagged if that trailer is due for maintenance or repairs. In other embodiments, a trailer may be flagged due to the trailer being decommissioned from operation. In other embodiments, the trailer may be flagged for other reasons. At operation 615, the yard check engine 205 designates the trailer to be picked up from the customer yard for maintenance, repairs, or resolving any issue that caused the trailer to be flagged. In some embodiments, the yard check engine 205 may also update the status of the trailer 210A. In some embodiments, the yard check engine 205 may update the status to indicate that the trailer 210A is empty. In other embodiments, the yard check engine 205 may update the status of the trailer 210A to indicate that the trailer 210A is out of rotation to prevent the trailer from being considered for assignment during the process 300. The process 600 then ends at operation 620.

On the other hand, if at the operation 610, the yard check engine 205 determines that the trailer 210A has not been flagged for any reason, at operation 625, the yard check engine updates the current status of the trailer to “empty.” In some embodiments in which the trailer 210A is designated to be unloaded at a future date, the yard check engine 205 may still mark the trailer as empty now or add a notation that the trailer is expected to be unloaded, and therefore become empty at the future date. In other embodiments, the yard check engine 205 may simply add the notation that the trailer 210A is expected to become empty at the future date, without updating the status of the trailer. At operation 630, the yard check engine 205 may additionally add the trailer 210A to the pool of empty trailers for assignment using the process 300. The process 600 then ends at the operation 620 waiting for another customer feedback.

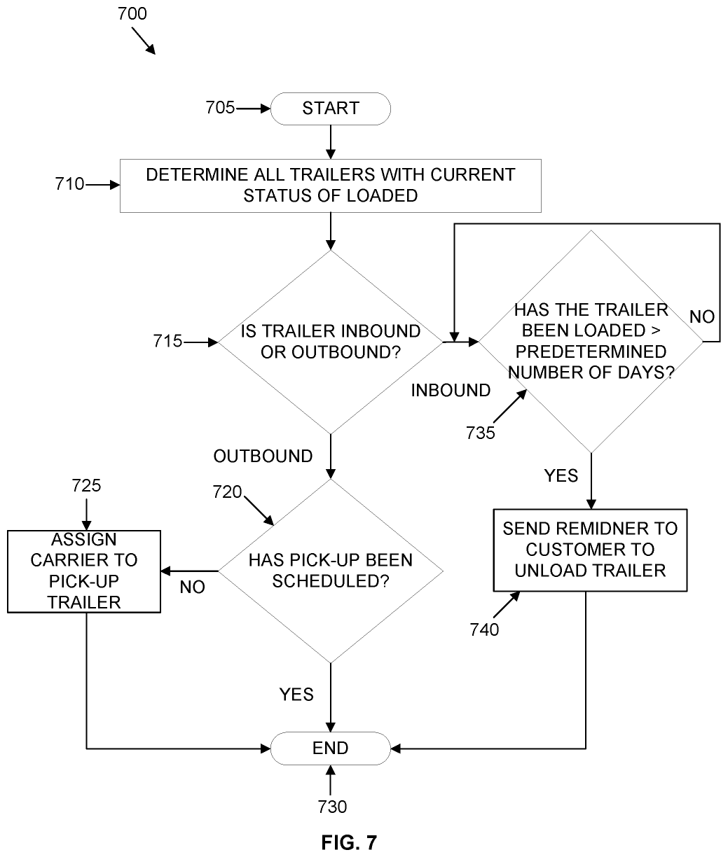

Referring to FIG. 7, an example flowchart outlining a process 700 is shown, in accordance with some embodiments of the present disclosure. The process 700 may be implemented by the yard check application 200. The process 700 may be used to provide alerts to customers based upon customer feedback and/or sensor data received from the sensors 240. Thus, upon starting at operation 705, the yard check engine 205 identifies all the trailers 210 of the customer that have a current status of loaded. In some embodiments, the yard check engine 205 may also identify all the trailers 210 that are not currently loaded but expected to be loaded soon. In some embodiments, the yard check engine 205 may identify the trailers 210 that have a current status of loaded based upon sensor data collected from the sensors 240 and/or based upon customer feedback (e.g., customer sending an indication via the customer portal 245 that a particular trailer is loaded or expected to be loaded soon). Similarly, in some embodiments, the yard check engine 205 may identify all the trailers 210 that have a status of to be loaded based upon customer feedback. In other embodiments, the yard check engine 205 may identify the trailers 210 that have a current status of loaded or to be loaded in other ways.

At operation 715, for each of the trailers 210 having the status of loaded or to be loaded, the yard check engine 205 determines whether that trailer has an additional status of inbound or outbound. For example, a trailer may have a status as “inbound loaded” if that trailer has arrived at the yard with loaded cargo for delivery at that yard. A trailer may have a status of “outbound loaded” if that trailer is currently on the yard, loaded or to be loaded, and ready to depart the yard. As such, a trailer may have a status as “inbound” if the trailer has arrived at the yard, and “outbound” if the trailer is ready to depart. At the operation 715, the yard check engine 205 may identify the trailers 210 that are loaded (or to be loaded) and have an “outbound” status, and identify the trailers that are loaded (or to be loaded) and have an “inbound” status. For each of the trailers 210 having an outbound status, at operation 720, the yard check engine 205 determines whether pick-up has been scheduled for that trailer. If a pick-up has not been scheduled for that trailer, at operation 725, the yard check engine 205 may assign a transport vehicle to pick up that trailer from the customer's yard for transportation, as discussed above with respect to FIG. 5 and the process 700 ends at operation 730.

On the other hand, at the operation 715, for each of the trailers 210 that have a status of inbound, the yard check engine 205 determines, at operation 735, how long each of those trailers has been sitting loaded on the customer's yard. In some embodiments, if the yard check engine 205 determines that a particular trailer has been sitting loaded on the yard for greater than a predetermined number of days, the yard check engine may send a reminder to the customer at operation 740. If the trailer has not been sitting loaded for greater than the predetermined number of days, the yard check engine 205 continues to monitor a change in the status of the trailer. For example, in some embodiments, the yard check engine 205 may continue to monitor the sensor data from the sensors 240 mounted on the trailer to determine when the status of the trailer changes from loaded to empty. In some embodiments, the yard check engine 205 may also monitor for customer feedback indicating that the trailer has been unloaded. Otherwise, the yard check engine 205 sends a reminder to the customer via the customer portal 245.

In some embodiments, the reminder may identify the name or identity of the trailer, the type of cargo loaded within the trailer, the location of the trailer on the customer yard, how long the trailer has been sitting loaded, and/or any other detail associated with the trailer. The reminder may take any of a variety of forms. In some embodiments, the yard check engine 205 may be configured to send color coded reminders. For example, in some embodiments, the yard check engine 205 may send a “warning” reminder having a first color upon determining that a trailer has been sitting loaded for a first predetermined number of days. Upon passing of a second predetermined number of days after the first predetermined number of days that the trailer is sitting loaded on the yard, the yard check engine 205 may send another “critical” reminder having a second color reminding the customer to unload the trailer. In some embodiments, the reminder may include a call to the customer. In other embodiments, the reminder may take other forms.

By monitoring the status of the trailers and reminding the customers to unload their trailers, the yard check application 200 helps customers with managing their orders and trailers. In some embodiments, the yard check engine 205 may similarly monitor the number of days a particular trailer has been sitting in a status of empty. For example, if a customer has too many trailers and not enough orders to fill all those trailers, the empty trailers may be sitting on the customer's yard. By actively monitoring the status of each of the customer's trailers, the yard check application 200 may provide accurate usage data to the customer of their trailers. Based upon the usage data, the customer may decide that the customer does not need as many trailers and may decide to reduce the number of trailers allocated thereto, thereby saving cost.

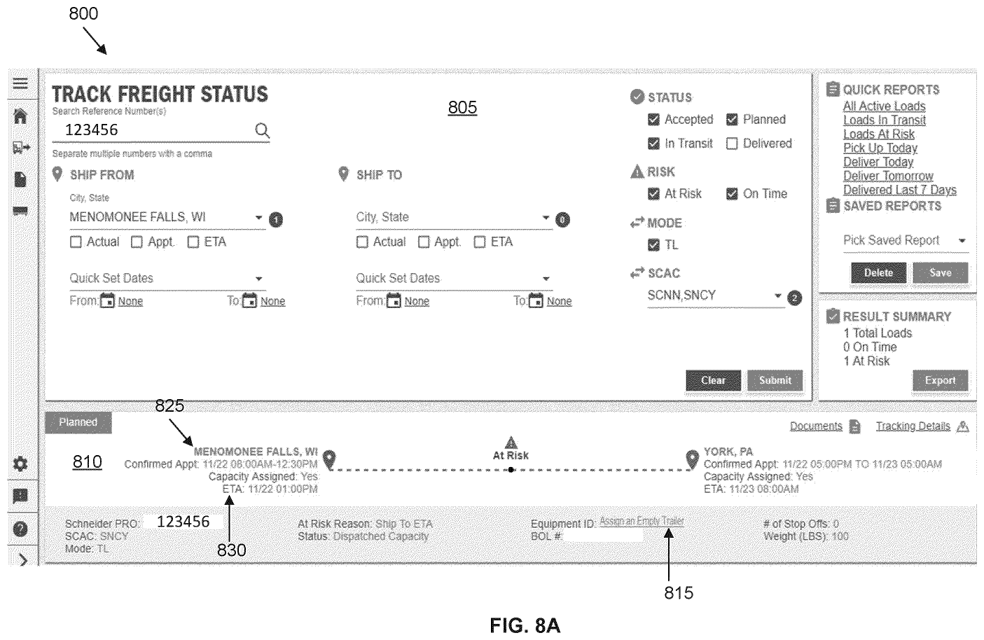

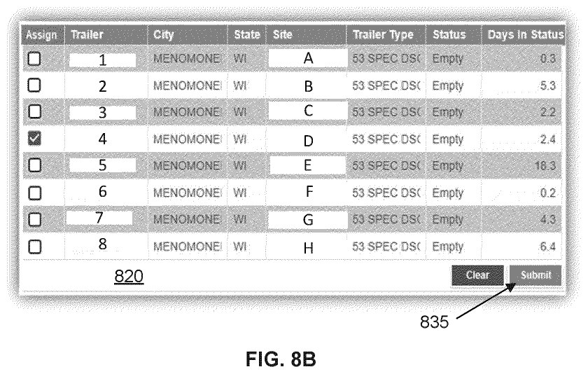

Referring now to FIGS. 8A and 8B, an example user interface 800 is shown, in accordance with some embodiments of the present disclosure. The user interface 800 may be accessed via the customer portal 245 and may be used to assign an empty trailer to an order. It is to be understood that the configuration of the user interface 800 is only an example and may vary in other embodiments. In some embodiments, the user interface 800 may be generated by the yard check engine 205 and displayed on the customer portal 245. In some embodiments, when the customer creates a new order or opens an existing order with which a trailer is not associated, to assign a trailer to that order, the customer may open the order to which a trailer is to be assigned. In some embodiments, the customer may search for a list of orders using one or more filters shown in a first portion 805 of the user interface 800. In some embodiments, a list of all orders that satisfy the filters set in the first portion 805 may be displayed in a second portion 810. From the list of orders, the customer may select one order, the details of which may be populated within the second portion 810. In other embodiments, the customer may open the order to which a trailer is to be assigned in other ways.

Upon viewing the order details of the order to which a trailer is to be assigned, the customer may interact with (e.g., click on) an “assign an empty trailer” option 815 to display a dialog box 820 shown in FIG. 8B. The dialog box 820 may provide a list of trailers that are empty (or expected to become empty), not assigned to other orders, and available to pick-up the order from a pick-up location 825 (see FIG. 8A) by a pick-up date 830 (see FIG. 8A) indicated in the order, as discussed above with respect to FIG. 3. From the list, the customer may select one or more trailers to assign to the order and interact with (e.g., click on) a submit button 835. Upon submission, the selected trailer(s) may be assigned to the order displayed in the second portion 810. For example, upon assignment, the “assign an empty trailer” option 815 may be changed to indicate the identity of the trailer that has been assigned. In a similar manner, the customer may easily and conveniently assign trailer(s) to all orders not having trailers assigned thereto.

In some embodiments, a dialog box (e.g., similar to the dialog box 820 but showing a list of loaded trailers) may be used to request a pick-up of a loaded trailer. For example, in some embodiments, the customer may select a trailer from the list of trailers that are loaded. Upon selecting the trailer, the customer may interact with (e.g., click on) a “pick-up now” or similar feature to send a request to the yard check application to pick up the trailer for transportation from the customer yard to a destination, as discussed above.

Thus, the present disclosure provides a convenient and effective mechanism to integrate an order management system with a trailer management system. The yard check application of the present disclosure provides a convenient mechanism to assign an empty trailer to a current order based upon trailer status, to request a transport vehicle to pick up a trailer that is ready to depart a customer's yard, and/or to take other actions based upon customer feedback.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
identifying, upon receiving an indication to assign a trailer to an order, an empty trailer from a plurality of trailers, wherein the empty trailer is identified based on customer feedback; and
assigning the empty trailer to the order.

2. The method of claim 1, further comprising removing the empty trailer from a pool of empty trailers upon assigning the empty trailer to the order.

3. The method of claim 1, further comprising identifying the empty trailer based upon a current status of each of the plurality of trailers, wherein the current status is determined from sensor data received from a sensor mounted on each of the plurality of trailers.

4. The method of claim 1, wherein identifying the empty trailer comprises:
determining a pick-up location of the order; and
identifying, based at least on the customer feedback, at least one of the plurality of trailers located at the pick-up location and having a current status of either empty or inbound loaded.

5. The method of claim 1, wherein identifying the empty trailer comprises:
determining a pick-up location of the order; and
identifying, based at least on the customer feedback, at least one of the plurality of trailers that is expected to be available at the pick-up location within a predetermined number of days before a ship date of the order.

6. The method of claim 1, wherein for a trailer of the plurality of trailers, the customer feedback comprises at least one indication indicating that:
the trailer is loaded;
the trailer is empty;
the trailer has arrived at a customer yard;
the trailer has departed from the customer yard; or
the trailer has been designated to be loaded or unloaded at a future time.

7. The method of claim 1, wherein upon receiving the customer feedback indicating that a trailer of the plurality of trailers is loaded, has departed from a customer yard, or has been designated to be loaded at a future time, the method comprises:
removing the trailer from a pool of empty trailers to obtain an updated pool of the empty trailers; and
selecting the empty trailer from the updated pool of the empty trailers.

8. The method of claim 1, wherein upon receiving the customer feedback indicating that a trailer of the plurality of trailers is unloaded, the method comprises:
adding the trailer to a pool of empty trailers to obtain an updated pool of the empty trailers; and
selecting the empty trailer from the updated pool of the empty trailers.

9. The method of claim 1, wherein upon receiving the customer feedback indicating that a trailer of the plurality of trailers has been designated to be unloaded at a predetermined future time, the method comprises:
determining whether the predetermined future time is within a predetermined number of days before a ship date associated with the order;
adding the trailer to a pool of empty trailers upon determining that the predetermined future time is within the predetermined number of days to obtain an updated pool; and
selecting the empty trailer from the updated pool of the empty trailers.

10. The method of claim 1, wherein identifying the empty trailer comprises:
determining a pool of empty trailers from the plurality of trailers; and
receiving selection of the empty trailer from the pool of empty trailers for assigning to the order.

11. The method of claim 10, wherein the pool of empty trailers comprises the plurality of trailers that are currently empty or expected to become empty within a predetermined number of days before a ship date associated with the order.

12. The method of claim 1, further comprising:
receiving the customer feedback that the empty trailer has been loaded for transportation from a customer yard to a destination;
determining a pick-up location of the customer yard;
determining a pick-up date by which the empty trailer is to be picked up; and
assigning a transport vehicle to pick up the empty trailer from the pick-up location by the pick-up date for transporting to the destination.

13. The method of claim 12, wherein assigning the transport vehicle comprises selecting the transport vehicle based upon at least one of a location of the transport vehicle, an order pick-up and order drop-off schedule of the transport vehicle, or a driver schedule.

14. The method of claim 1, wherein upon receiving the customer feedback indicating that a trailer of the plurality of trailers has been unloaded, the method further comprises:
determining that the trailer has been flagged; and
resolving an issue that caused the trailer to be flagged before allowing the trailer to be assigned to another order.

15. The method of claim 1, further comprising:
identifying a trailer from the plurality of trailers that has been in a current status of loaded for greater than a predetermined number of days; and
sending an alert to a customer upon determining that the trailer has been in the current status of loaded for greater than the predetermined number of days.

16. One or more non-transitory computer-readable storage media comprising computer-readable instructions stored thereon that when executed by a processor of a yard check application cause the processor to:
identify, upon receiving an indication to assign a trailer to an order, an empty trailer from a plurality of trailers, wherein the empty trailer is identified based on customer feedback; and
assign the empty trailer to the order.

17. The one or more non-transitory computer-readable storage media of claim 16, wherein the processor further executes computer-readable instructions to:
receive the customer feedback that the empty trailer has been loaded for transportation from a customer yard to a destination;
determine a pick-up location of the customer yard;
determine a pick-up date by which the empty trailer is to be picked up; and
assign a transport vehicle to pick up the empty trailer from the pick-up location by the pick-up date for transporting to the destination.

18. The one or more non-transitory computer-readable storage media of claim 16, wherein the processor receives the customer feedback from a customer portal that is associated with a customer sending the customer feedback, and wherein the customer portal is separate from and associated with the yard check application.

19. One or more non-transitory computer-readable storage media comprising computer-readable instructions stored thereon that when executed by a processor of a yard check application cause the processor to:
receive customer feedback indicating that a trailer has been loaded for transportation from a customer yard to a destination;
determine a pick-up location of the customer yard;
determine a pick-up date by which the trailer is to be picked up; and
assign a transport vehicle to pick up the trailer from the pick-up location by the pick-up date for transporting the trailer to the destination.

20. The one or more non-transitory computer-readable storage media of claim 19, wherein assigning the transport vehicle comprises selecting the transport vehicle based upon at least one of a location of the transport vehicle, an order pick-up and order drop-off schedule of the transport vehicle, or a driver schedule.
